(19) United States
(12) Patent Application Publication
(10) Pub. No.: US 2015/0306753 A1
(43) Pub. Date: Oct. 29, 2015

(54) ADJUSTING DEVICE FOR AN ELECTRIC NAIL GUN

(71) Applicant: BASSO INDUSTRY CORP., Taichung (TW)

(72) Inventors: Chien-Kuo PO, Taichung (TW); Chia-Yu CHIEN, Taichung (TW); Jian-Rung WU, Taichung (TW)

(21) Appl. No.: 14/691,078

(22) Filed: Apr. 20, 2015

(30) Foreign Application Priority Data
Apr. 23, 2014 (TW) 103114660

(51) Int. Cl. B25C 1/06; B25C 7/00

(52) U.S. Cl. CPC B25C 1/06; B25C 7/00

(57) ABSTRACT

An adjusting device for an electric nail gun includes a detecting unit, a sensing unit and an electric control unit. The detecting unit includes a detecting rod for being pushed by a nail received in the electric nail gun to be rotated. The sensing unit is for sensing the position of the detecting rod and generating a corresponding sensing signal. The electric control unit is electrically connected to a driving unit of the electric nail gun and the sensing unit, and switches the driving unit to a state corresponding to the sensing signal.

### CROSS-REFERENCE TO RELATED APPLICATION

This application claims priority of Taiwanese Application No. 103114660, filed on Apr. 23, 2014.

### FIELD

The disclosure relates to an adjusting device, and more particularly to an adjusting device for use in an electric nail gun.

### BACKGROUND

Referring to FIG. 1, Taiwanese Patent Application No. 101110812 discloses a conventional electric nail gun 1 including a gun body 10, a nail path 11 that is formed in an end portion of the gun body 10, a flywheel 12 that is mounted rotatably to the gun body 10, a motor 13 that is mounted to the gun body 10 for driving rotation of the flywheel 12, a swing arm 14 that is pivoted to the gun body 10, an impact member 15 that is mounted slidably to the swing arm 14, a magazine 16 that receives a plurality of nails and that is connected to the gun body 10 for moving the nails into the nail path 11 one at a time, and a nail striking blade 17 that is connected co-movably to the impact member 15.

The impact member 15 is movable in response to the pivot movement of the swing arm 14 relative to the gun body 10 to contact the flywheel 12, and is thereby driven by the flywheel 12 to move along an axis (A) toward the nail path 11, so as to drive the nail striking blade 17 to move within the nail path 11 to perform a nail-striking operation.

In practice, the abovementioned conventional electric nail gun 1 may be used to fire nails that are different in length. Since the motor 13 outputs constant driving energy, the flywheel 12 cannot driven by the motor 13 to store a sufficient rotational energy for firing a relatively long nail.

Referring to FIG. 2, U.S. Pat. No. 6,739,490 discloses another conventional electric nail gun that includes a magazine 91 receiving a plurality of nails 90 therein, a detecting rod 92 connected pivotally to the magazine 91, and a sensing component 93 contactable with the detecting rod 92. When the nails 90 received in the magazine 91 are relatively long, the detecting rod 92 is pushed by one of the nails 90 to rotate, so as to contact the sensing component 93 for adjusting driving energy of a motor (not shown).

However, the one of the nails 90 that pushes the detecting rod 92 is spaced apart from a nail path (not shown) of the conventional electric nail gun. That is, when the one of the nails 90 that pushes the detecting rod 92 and the nail 90 that is received in the nail path are different in length, the motor may output inadequate driving energy for firing the nail 90 that is received in the nail path. Moreover, when the number of the nails 90 in the magazine 91 is not enough to contact the detecting rod 92 with the nails, the motor may also output an inadequate driving energy for firing the nail 90.

In addition, the conventional electric nail gun of U.S. Pat. No. 6,739,490 can output only two different magnitudes of driving energy for firing nails 90, and therefore lacks flexibility for being suitable for various kinds of nails 90.

### SUMMARY

Therefore, an object of the disclosure is to provide an adjusting device that can overcome at least one of the aforesaid drawbacks associated with the prior arts.

According to the disclosure, the adjusting device is for use in an electric nail gun. The electric nail gun includes a gun body, a driving unit mounted in the gun body, a head seat connected to a front end of the gun body and formed with a nail path, and a magazine receiving a plurality of nails and connected to the head seat for moving the nails into the nail path one at a time. The driving unit is switchable between different states so as to provide different magnitudes of driving energy to perform a nail-striking operation. Each of the nails has a head portion and a tip opposite to the head portion. The adjusting device includes a detecting unit, a sensing unit and an electric control unit. The detecting unit includes a detecting rod that is mounted to the electric nail gun. The detecting rod has a detecting portion for being pushed by the tip of one of the nails so that the detecting rod is rotated relative to the electric nail gun. The sensing unit is mounted to the electric nail gun for sensing the position of the detecting portion of the detecting rod relative to the electric nail gun, and generating a sensing signal corresponding to the position of the detecting portion of the detecting rod relative to the electric nail gun. The detecting rod is movable relative to the head seat and the sensing unit. The electric control unit is mounted to the electric nail gun and is electrically connected to the driving unit and the sensing unit. The electric control unit switches the driving unit to one of the states corresponding to the sensing signal generated by the sensing unit.

### BRIEF DESCRIPTION OF THE DRAWINGS

Other features and advantages of the disclosure will become apparent in the following detailed description of the embodiments with reference to the accompanying drawings, of which:

FIG. 1 is a side view of a conventional electric nail gun of Taiwanese Patent Application No. 101110812;

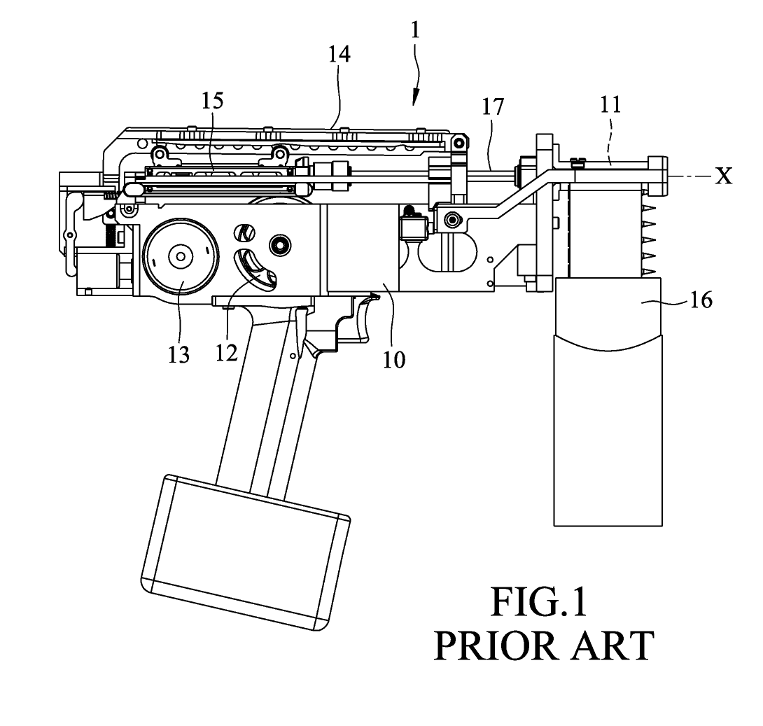

FIG. 2 is a fragmentary perspective view of another conventional electric nail gun of U.S. Pat. No. 6,739,490;

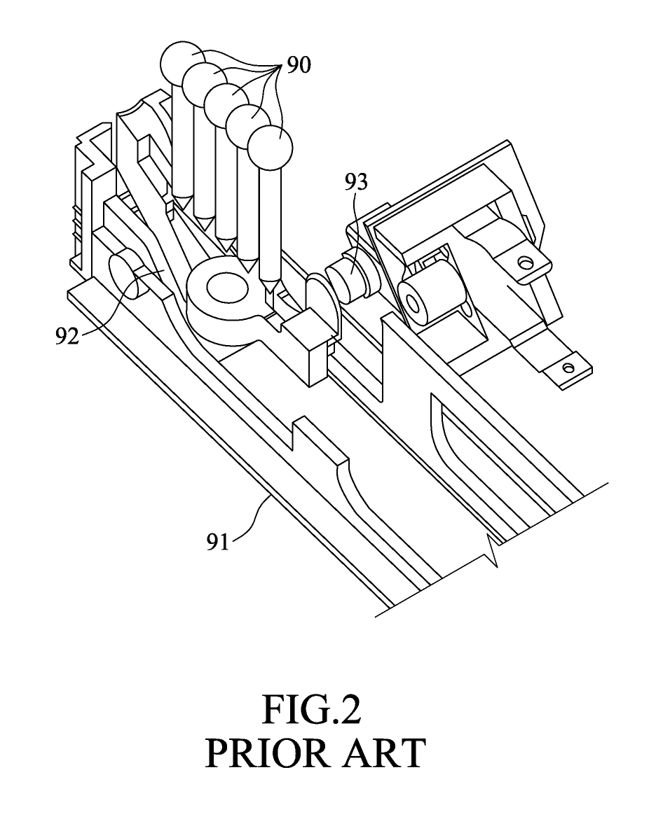

FIG. 3 is a side view of an electric nail gun including a first embodiment of an adjusting device according to the disclosure;

FIG. 4 is a fragmentary front sectional view of the electric nail gun;

FIG. 5 is a fragmentary side view of the electric nail gun;

FIG. 6 is another fragmentary front sectional view of the electric nail gun;

FIG. 7 is a fragmentary side view of an electric nail gun including a second embodiment of the adjusting device according to the disclosure; and

FIG. 8 is another fragmentary side view of an electric nail gun.

### DETAILED DESCRIPTION

Before the disclosure is described in greater detail, it should be noted that like elements are denoted by the same reference numerals throughout the disclosure.

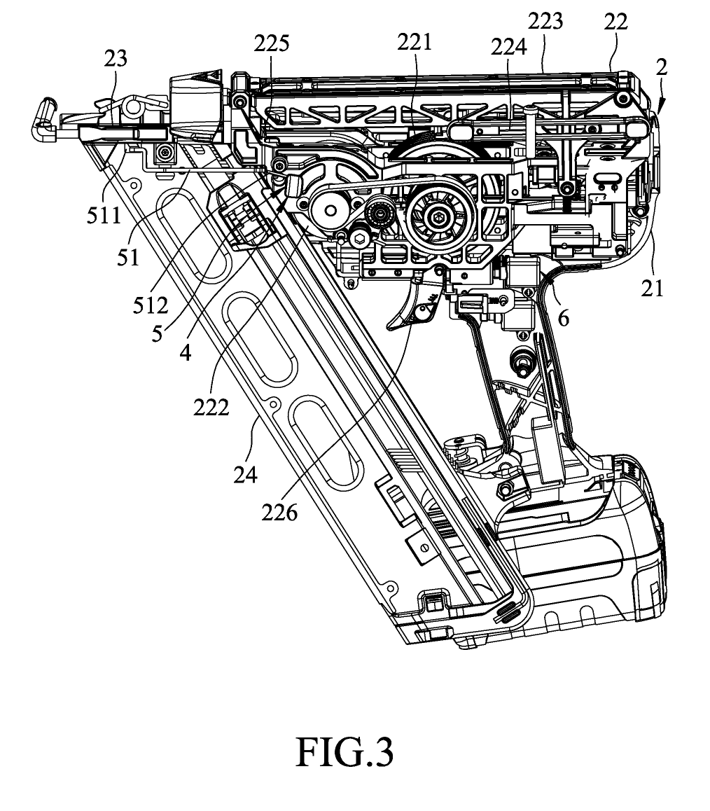

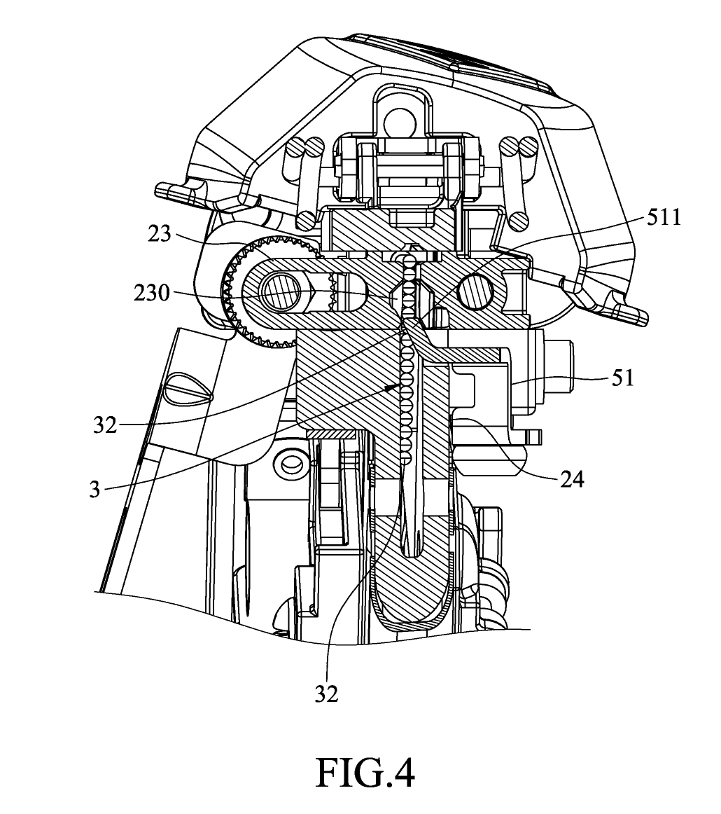

Referring to FIGS. 3 and 4, a first embodiment of an adjusting device according to the disclosure is used in an electric nail gun 2. The electric nail gun 2 includes a gun body 21, a driving unit 22 mounted in the gun body 21, a head seat 23 connected to a front end of the gun body 21 and formed with a nail path 230, and a magazine 24 receiving a plurality of nails 3 and connected to the head seat 23 for moving the nails 3 into the nail path 230 one at a time.

The driving unit 22 is switchable between different states so as to provide different magnitudes of driving energy to perform a nail-striking operation. In this embodiment, the driving unit 22 includes a flywheel 221 mounted rotatably in the gun body 21, a motor 222 mounted to the gun body 21 for driving rotation of the flywheel 221, a swing arm 223 pivoted to the gun body 21, an impact member 224 mounted slidably to the swing arm 14, a nail striking blade 225 connected co-movably to the impact member 224, and a trigger member 226 pivoted to the gun body 21 for being pressed to generate a trigger signal.

Each of the nails 3 has a head portion 31 and a tip 32 opposite to the head portion 31. The head portion 31 of one of the nails 3 that is received in the nail path 230 is disposed at a predetermined position relative to the electric nail gun 2.

The first embodiment of the adjusting device includes a sensing unit 4, a detecting unit 5 and an electric control unit 6.

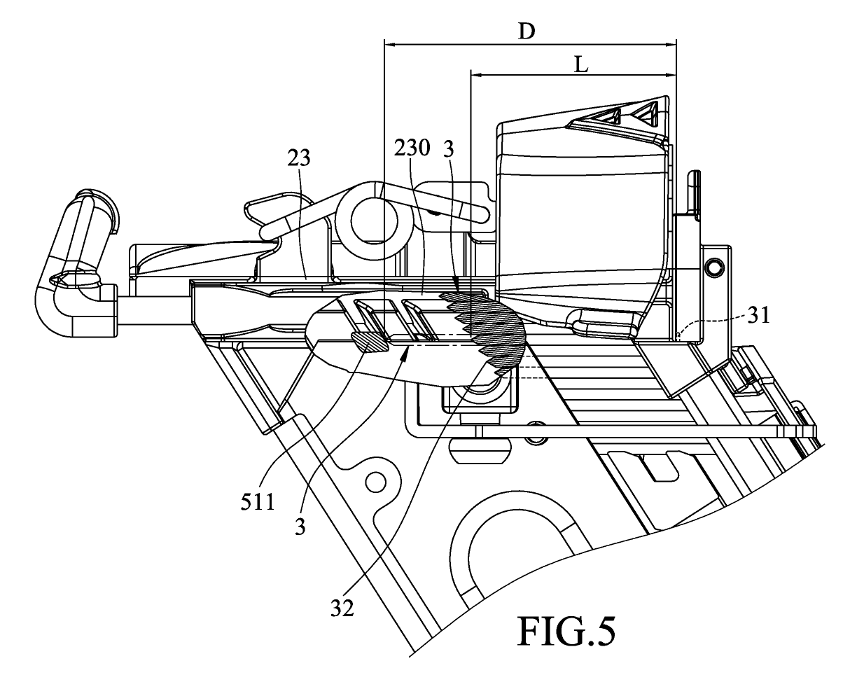

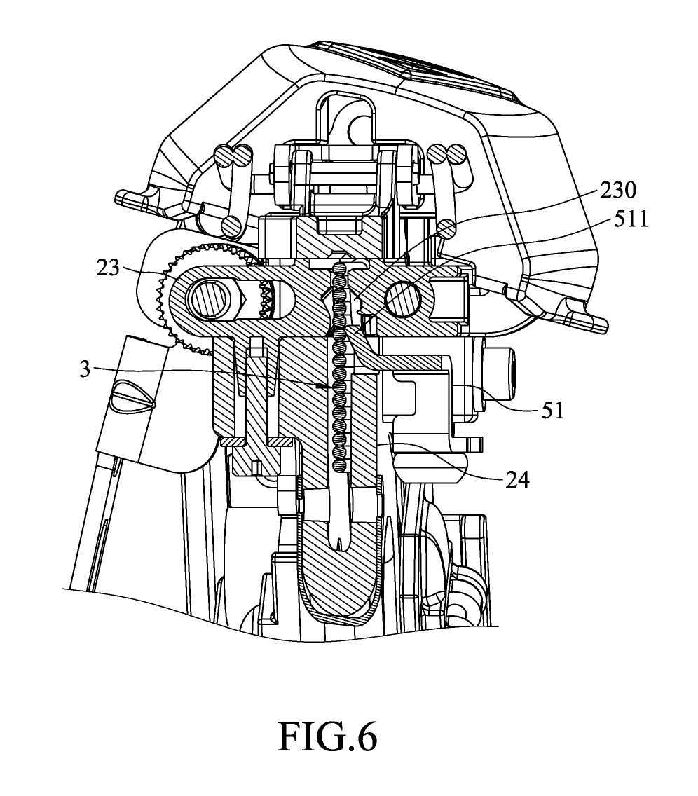

The detecting unit 5 includes a detecting rod 51. The detecting rod 51 has an intermediate portion that is pivoted to the head seat 23, a first end portion that serves as a detecting portion 511, and a second end portion that is opposite to the first end and that serves as a contact portion 512. The detecting portion 511 of the detecting rod 51 is movable relative to the electric nail gun 2 between a first position (see FIGS. 4 and 5) whereat the detecting portion 511 is moved into the nail path 230, and a second position (see FIG. 6) whereat the detecting portion 511 is removed from the nail path 230.

The sensing unit 4 is mounted to an outer surface of the gun body 21 for generating a sensing signal when contacted. In this embodiment, the sensing unit 4 is configured as a microswitch.

The electric control unit 6 is mounted to the gun body 21 of the electric nail gun 2 and electrically connected to the driving unit 22, the sensing unit 4 and the trigger member 226.

Referring further to FIG. 5, when a nail distance (L) between the tip 32 and the head portion 31 of the one of the nails 3 received in the nail path 230 is smaller than or equal to a sensing distance (D) between the detecting portion 511 and the head portion 31 of the one of the nails 3 received in the nail path 230, the detecting portion 511 of the detecting rod 51 is at the first position and the contact portion 512 is spaced apart from the sensing unit 4. At this time, the motor 222 is in a first state, and the electric control unit 6 controls an output shaft of the motor 222 to rotate at a first speed upon receiving the trigger signal generated by the trigger member 226, so as to drive the flywheel 221 to store driving energy for firing the one of the nails 3 received in the nail path 230.

Referring further to FIG. 6, when the nail distance (L) between the tip 32 and the head portion 31 of the one of the nails 3 received in the nail path 230 is greater than the sensing distance (D) between the detecting portion 511 and the head portion 31 of the one of the nails 3 received in the nail path 230, the detecting portion 511 of the detecting rod 51 is pushed by the tip 32 of the one of the nails 3 received in the nail path 230 to move to the second position so that the detecting rod 51 is rotated to move the contact portion 512 to contact the sensing unit 4, and the electric control unit 6 switches the motor 222 to a second state upon receiving the sensing signal generated by the sensing unit 4. At this time, the electric control unit 6 controls the output shaft of the motor 222 to rotate at a second speed that is higher than the first speed upon receiving the trigger signal generated by the trigger member 226, so as to drive the flywheel 221 to store greater driving energy for firing the one of the nails 3 received in the nail path 230 that has a relatively long nail distance (L).

The advantages of the first embodiment are as follows:

1. The detecting portion 511 of the detecting rod 51 directly detects the nail distance (L) between the tip 32 and the head portion 31 of the nail 3 received in the nail path 230, so that the electric control unit 6 controls the output shaft of the motor 222 to rotate at an adequate speed for firing the nail 3 received in the nail path 230.

2. The detecting rod 51 is disposed outside the magazine 24, so as not to interfere with the nails 3 received in the magazine 24, and not to occupy the space in the magazine 24.

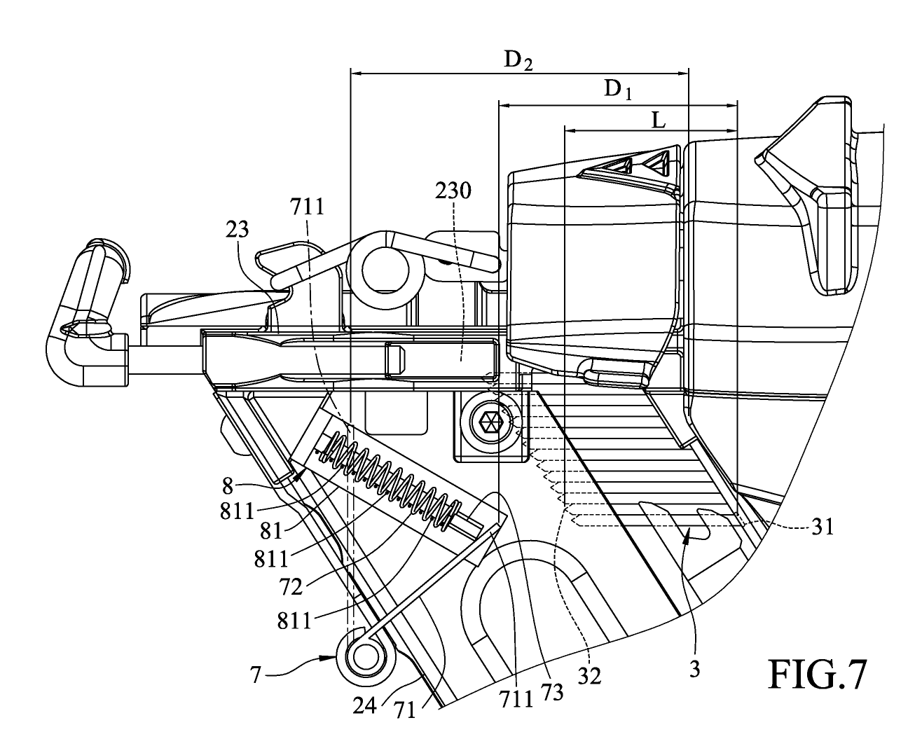

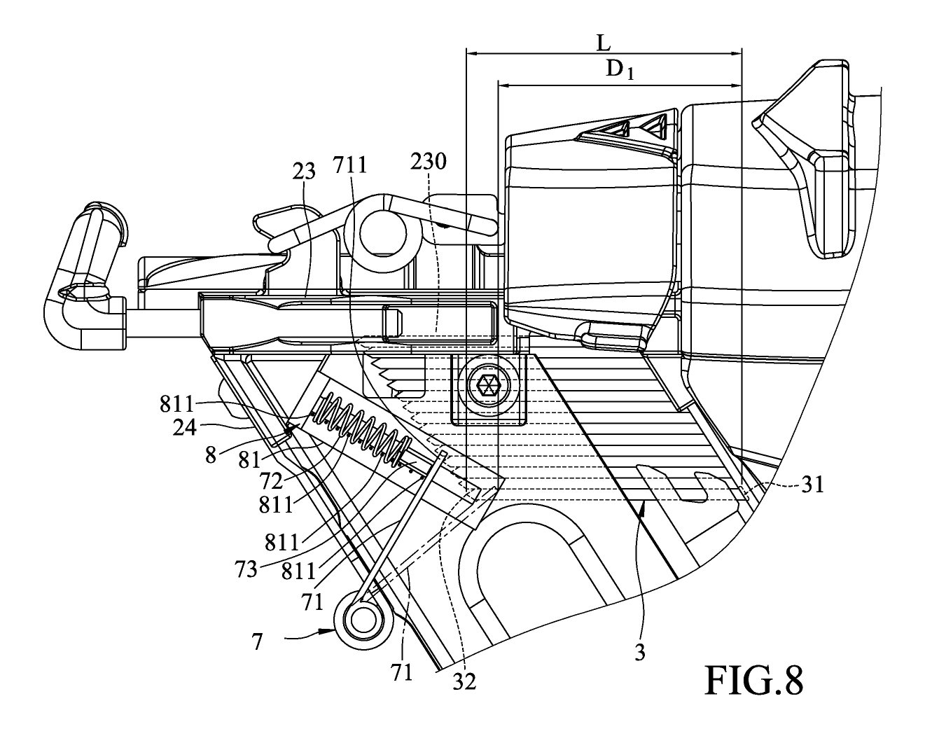

Referring to FIGS. 7 and 8, a second embodiment of the adjusting device according to the disclosure includes a detecting unit 7, a sensing unit 8 and an electric control unit 6 (referring to FIG. 3).

The detecting unit 7 is disposed in the magazine 24, and includes a detecting rod 71, a resilient member 72 and a contact member 73. The detecting rod 71 is pivoted to the magazine 24. The detecting portion 711 of the detecting rod 71 is movable relative to the magazine 24 along an arc-shaped trajectory between a first position where the detecting portion 711 is proximate to the head portions 31 of the nails 3, and a second position that is farther away from the head portions 31 of the nails 3 than the first position. The detecting portion 711 and the head portion 31 of one of the nails 3 that is aligned with the detecting portion 711 in the direction of the nail path 230 cooperatively define a first distance (D1) therebetween when the detecting portion 711 of the detecting rod 71 is at the first position. The detecting portion 711 and the head portion 31 of the one of the nails 3 that is aligned with the detecting portion 711 in the direction of the nail path 230 further cooperatively defining a second distance (D2) therebetween when the detecting portion (711) of the detecting rod (71) is at the second position. The detecting rod 71 is pushed by the tip 32 of the one of the nails 3 that is aligned with the detecting portion 711 in the direction of the nail path 230 to move toward the second position when the nail distance (L) between the tip 32 and the head portion 31 of the nail 3 is greater than the first distance (D1). The contact member 73 is biased to abut against the detecting portion 711 of the detecting rod 71 and is pushed by the detecting rod 71 to move in the magazine 24 when the detecting portion 711 moves from the first position to the second position. The resilient member 72 has opposite ends abutting respectively against the magazine 24 and the contact member 73 for biasing resiliently contact member 73 to abut against the detecting rod 71 so as to bias the detecting portion 711 of the detecting rod 71 toward the first position.

The sensing unit 8 is mounted in the magazine 24, and includes a straight sensing member 81 that has a plurality of sensing points 811 arranged therealong. The sensing points 811 are disposed within a region that is contactable with the detecting rod 71. The contact member 73 is movable along the sensing member 81.

Referring to FIG. 7, when the nail distance (L) of the one of the nails 3 that is aligned with the detecting portion 711 in the direction of the nail path 230 is smaller than the first distance (D1), the motor 222 (referring to FIG. 3) is in an initial state, and the electric control unit 6 controls the output shaft of the motor 222 to rotate at an initial speed upon receiving the trigger signal generated by the trigger member 226 (referring to FIG. 3), so as to drive the flywheel 221 (referring to FIG. 3) to store driving energy for firing the nail 3 received in the nail path 230.

Referring further to FIG. 8, when the nail distance (L) of the one of the nails 3 that is aligned with the detecting portion 711 in the direction of the nail path 230 is greater than the first distance (D1) and smaller than the second distance (D2), the detecting rod 71 is pushed by the tip 32 of the one of the nails 3 to move the contact member 73 to contact a corresponding one of the sensing points 811 of the sensing member 81, such that the corresponding one of the sensing points 811 generates a sensing signal for switching the motor 222 to a corresponding state. At this time, the electric control unit 6 controls the output shaft of the motor 222 to rotate at a corresponding speed upon receiving the trigger signal generated by the trigger member 226, so as to drive the flywheel 221 to store the driving energy for firing the nail 3 received in the nail path 230. Preferably, the electric control unit 6 controls the output shaft of the motor 222 to rotate at a relatively high speed upon receiving the trigger signal generated by the trigger member 226 after receiving the sensing signal generated by one of the sensing points 811 that is relatively far from the head portions 31 of the nails 3.

To sum up, the second embodiment of the adjusting device controls the motor 222 to switch among more than two states, so that the flywheel 221 is driven to store the driving energy suitable for various kinds of nails 3.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An adjusting device adapted for use in an electric nail gun, the electric nail gun including a gun body, a driving unit mounted in the gun body, a head seat connected to a front end of the gun body and formed with a nail path, and a magazine receiving a plurality of nails and connected to the head seat for moving the nails into the nail path one at a time, the driving unit being switchable between different states so as to provide different magnitudes of driving energy to perform a nail-striking operation, each of the nails having a head portion and a tip opposite to the head portion, said adjusting device comprising:
a detecting unit including a detecting rod that is adapted to be mounted to the electric nail gun, said detecting rod having a detecting portion that is adapted for being pushed by the tip of one of the nails so that said detecting rod is rotated relative to the electric nail gun;
a sensing unit adapted to be mounted to the electric nail gun for sensing the position of said detecting portion of said detecting rod relative to the electric nail gun, and generating a sensing signal corresponding to the position of said detecting portion of said detecting rod relative to the electric nail gun, said detecting rod being adapted to be movable relative to the head seat and said sensing unit; and
an electric control unit adapted to be mounted to the electric nail gun and electrically connected to the driving unit and said sensing unit, said electric control unit switching the driving unit to one of the states corresponding to the sensing signal generated by said sensing unit.

2. The adjusting device as claimed in claim 1, the head portion of one of the nails that is received in the nail path being disposed relative to the electric nail gun at a predetermined position, wherein, said detecting portion of said detecting rod is adapted to be movable relative to the electric nail gun between a first position where said detecting portion is moved into the nail path, and a second position where said detecting portion is removed from the nail path, said detecting portion of said detecting rod being at the first position when a distance between the tip and the head portion of the one of the nails that is received in the nail path is smaller than or equal to a distance between said detecting portion and the head portion of the one of the nails received in the nail path, said detecting portion of said detecting rod being pushed by the tip of the one of the nails received in the nail path to move to the second position when the distance between the tip and the head portion of the one of the nails is greater than the distance between said detecting portion and the head portion of the one of the nails received in the nail path.

3. The adjusting device as claimed in claim 2, wherein said sensing unit is adapted to be mounted to an outer surface of the gun body, said detecting rod having an intermediate portion that is adapted to be pivoted to the head seat, a first end portion that serves as said detecting portion, and a second end portion that is opposite to said first end and that serves as a contact portion for contacting said sensing unit when said detecting portion of said detecting rod is at the second position.

4. The adjusting device as claimed in claim 1, wherein said sensing unit is adapted to be mounted in the magazine, said detecting rod being adapted to be pivoted to the magazine, said detecting portion of said detecting rod being adapted to be movable relative to the magazine between a first position where said detecting portion is proximate to the head portions of the nails, and a second position that is farther away from the head portions of the nails than the first position, said detecting portion and the head portion of one of the nails that is aligned with said detecting portion in the direction of the nail path cooperatively defining a first distance therebetween when said detecting portion of said detecting rod is at the first position, said detecting rod being pushed by the tip of the one of the nails that is aligned with said detecting portion in the direction of the nail path to move toward the second position when the distance between the tip and the head portion of the nail is greater than the first distance, said detecting unit further including a contact member that is biased to abut against said detecting portion of said detecting rod and that is pushed by said detecting rod to move in the magazine when said detecting portion moves from the first position to the second position.

5. The adjusting device as claimed in claim 4, wherein said detecting unit further includes a resilient member that has opposite ends abutting respectively against the magazine and said contact member for biasing resiliently said detecting portion of said detecting rod toward the first position.

6. The adjusting device as claimed in claim 5, wherein said detecting portion and the head portion of the one of the nails that is aligned with said detecting portion in the direction of the nail path further cooperatively defining a second distance therebetween when said detecting portion of said detecting rod is at the second position, said sensing unit including a straight sensing member that has a plurality of sensing points arranged therealong, said sensing points being disposed within a region that is contactable with said detecting rod, said contact member being movable along said sensing member, said detecting rod being pushed by the tip of the one of the nails that is aligned with said detecting portion in the direction of the nail path to move said contact member to contact a corresponding one of said sensing points of said sensing member when the length of the nail is greater than the first distance and smaller than the second distance, such that the corresponding one of said sensing points generates the sensing signal for switching the driving unit to a corresponding one of the states.

7. The adjusting device as claimed in claim 1, the driving unit including a motor, wherein said electric control unit controls an output shaft of the motor to rotate at a speed corresponding to the sensing signal generated by said sensing unit.
